(19) United States
(12) Patent Application Publication
(10) Pub. No.: US 2011/0302971 A1
(43) Pub. Date: Dec. 15, 2011

(54) ADJUSTABLE TURN PIECE EXTENSION

(76) Inventor: Jeanette Vy BUI, Irvine, CA (US)

(21) Appl. No.: 12/796,871

(22) Filed: Jun. 9, 2010

(51) Int. Cl. E05B 17/00; B23P 17/04; E05B 63/00

(52) U.S. Cl. 70/461; 29/428

(57) ABSTRACT

An adjustable turn piece extension includes a first member, a second member, and a connecting pin. The first member includes a slot and the second member is configured to fit in the slot. Apertures on the first and second members can be aligned to receive the connecting pin and thereby determine the length of the turn piece.

The present invention relates to turn pieces used in mortise lock installations and particularly to turn pieces that are adjustable to allow use in doors of differing thicknesses.

### BRIEF DESCRIPTION OF THE DRAWINGS

FIG. 1 is a section view taken through a single-cylinder mortise cylinder assembly for use in a mortise lock.

FIG. 2 is a perspective assembly view of an adjustable turn piece extension for use in the cylinder assembly of FIG. 1.

FIG. 3 is a perspective view of the adjustable turn piece extension in a first configuration.

FIG. 4 is a perspective view of the adjustable turn piece extension in a second configuration.

FIG. 5 is a section view taken through the adjustable turn piece extension in the first configuration.

FIG. 6 is a top view of the adjustable turn piece extension in the first configuration.

FIG. 7 is an exploded view of the mortise cylinder assembly of FIG. 1.

### DETAILED DESCRIPTION OF THE DRAWINGS

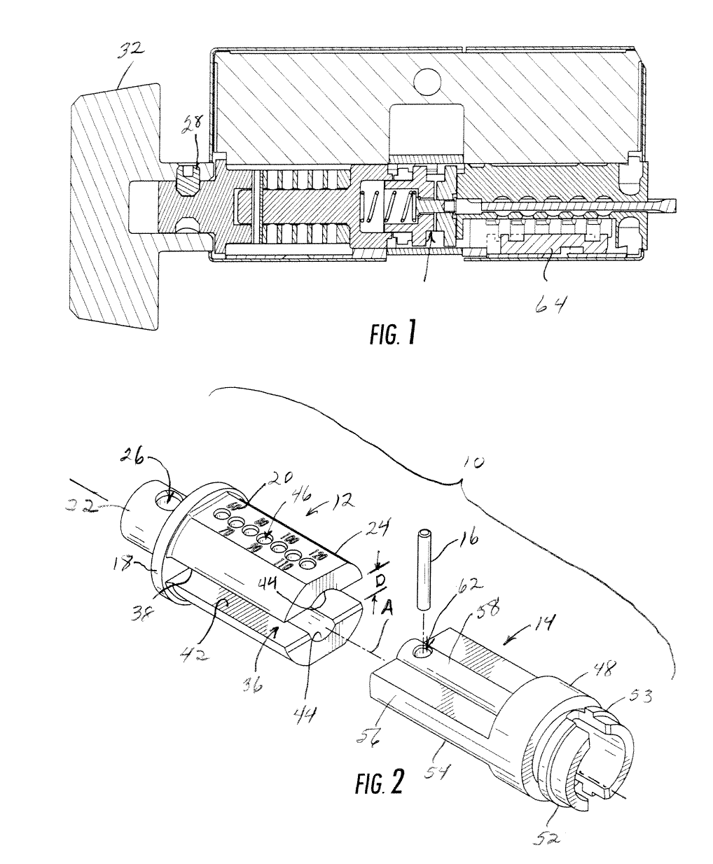

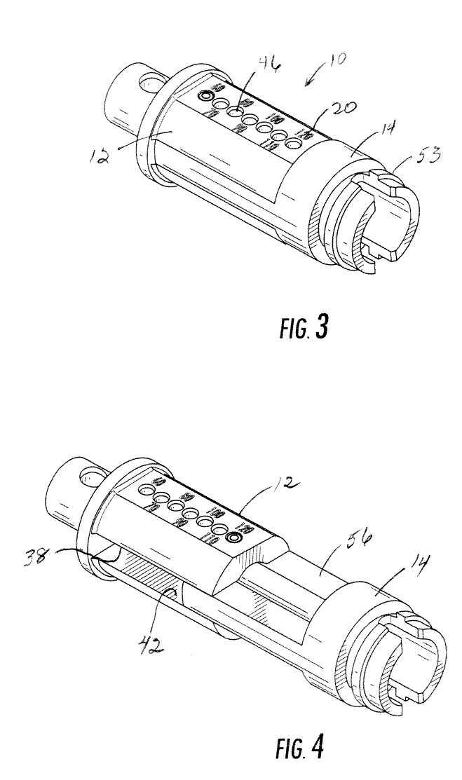

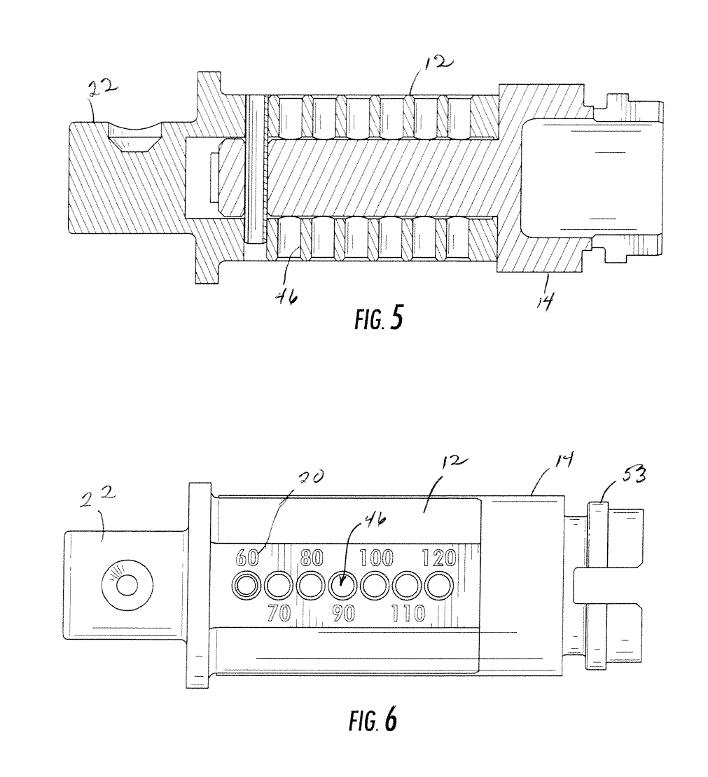

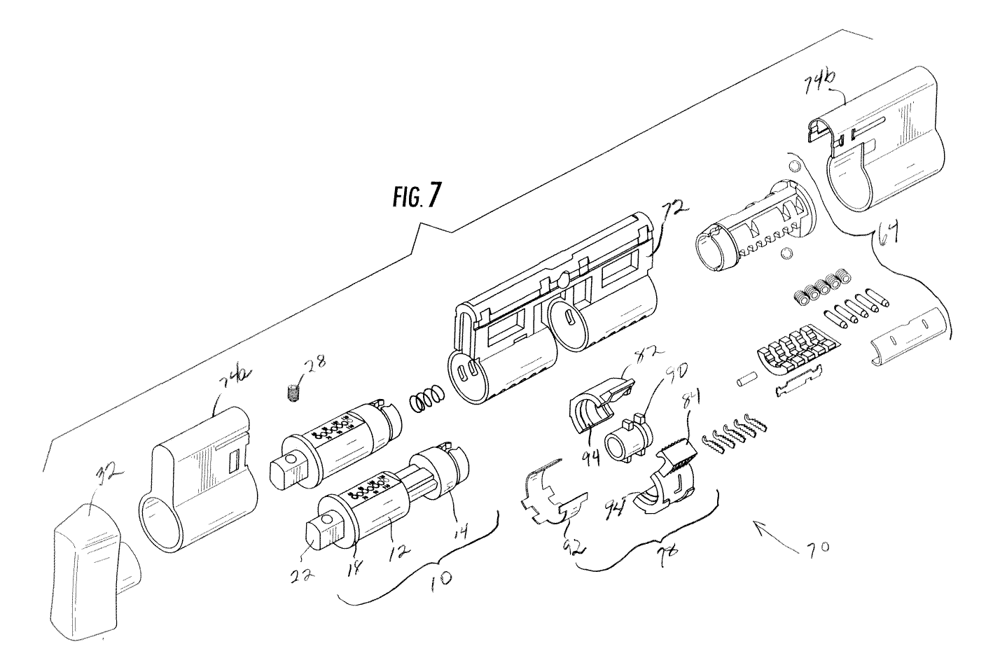

As illustrated in FIGS. 1 and 2, an adjustable turn piece extension 10 with a longitudinal axis A can include a first member 12, a second member 14, and a connecting pin 16. Preferred embodiments can also include indicia 20 for indicating suitable door thicknesses.

The first member 12 can include a generally circular plate 18, a cylindrical lug portion 22 extending longitudinally in the opposite direction from the plate 18, and an outer shaft portion 24 extending longitudinally in a second direction from the plate 18. The lug portion 22 can include an aperture 26 to receive a set screw 28 for rotationally locking a conventional turn piece 32 to the lug portion 22. The outer shaft portion 24 can define a slot 36 that extends longitudinally from the plate 18 and through the outer shaft 24. The slot 36 can be defined by upper and lower surfaces 38, 42, respectively, separated by a predetermined distance D. Each surface 38, 42 can include a channel 44 extending longitudinally from the plate 18. The shaft portion 24 can also include a plurality of apertures 46 extending along the length of the shaft portion 24, with each aperture 46 passing through the shaft portion 24. The spacing between the apertures 46 can be predetermined to conform to varying door thicknesses. In some preferred embodiments, indicia 20 can be included to indicate a particular door thickness to be associated with each aperture 46.

The second member 14 can include a circular plate 48, a clutch-engaging portion 52 extending longitudinally from the plate 48 in a first direction, and an inner shaft portion 54 extending longitudinally from the plate 48 in the opposite direction. The clutch-engaging portion 52 can be configured to operate in conjunction with a conventional clutch mechanism to connect the turn piece 32 to a conventional lock cylinder 64. In some embodiments, the clutch-engaging portion 52 can include an annular flange 53 disposed axially from the plate 48. The inner shaft portion 54 can include a plate portion 56 that includes upper and lower ridges 58. The lower ridge is not shown, but is a mirror image of the upper ridge. The plate portion 56 and upper and lower ridges 58 can be sized and configured to fit in the slot 36 between the upper and lower surfaces 38, 42, with the ridges 58 positioned in the channels 44. The plate portion 56 can also include an aperture 62 for receiving the connecting pin 16. The aperture 62 can be positioned in registry with any of the apertures 46 by sliding the inner shaft 54 in and out of the slot 36. The connecting pin 16 can then be inserted through the apertures 46, 62 to lock the first and second members 12, 14 together.

A mortise lock assembly 70 for use with the turn piece extension 10, as illustrated in FIGS. 1 and 7, can include a lock cylinder housing 72 and a cover 74a, 74b generally surrounding the cylinder housing 72. A lock cylinder 64 can be disposed in one end of the cylinder housing 72, with the turn piece extension 10 disposed in the other end of the cylinder housing 72. An operating cam 78 can be disposed in the cylinder housing 72 intermediate the lock cylinder 64 and the turn piece extension 10. A turn piece 32 is coupled to the turn piece extension 10 by the set screw 28.

The operating cam 78 is of conventional design and includes cam halves 82, 84 that combine to form an annular portion and a lug portion, with a clutch 90 disposed within the annular portion. A retainer clip 92 holds the cam halves 82, 84 together. Each cam half 82, 84 includes an internal annular groove 94 for capturing the annular flange 53 on the clutch-engaging portion 52 of the turn piece extension 10 and a similar flange formed on the lock cylinder 64.

It should be understood that the detailed description and specific examples, while indicating the preferred embodiment of the invention, are intended for purposes of illustration only and are not intended to limit the scope of the invention.

1. A turn piece extension for use with a lock cylinder housing, the turn piece extension comprising:
a first member having a first aperture and a slot;
a second member disposed in the slot and including a second aperture aligned with the first aperture, the first and second members being disposed in the lock cylinder housing; and
a connecting pin disposed in the first and second apertures.

2. The turn piece extension of claim 1 wherein the slot is defined by an upper surface and a lower surface, with each surface including channel extending parallel to a longitudinal axis of the first member.

3. The turn piece extension of claim 1 wherein the first member includes a plurality of apertures and indicia indicating a door thickness.

4. A turn piece extension for use with a lock cylinder housing, the turn piece extension comprising:
a first member having a longitudinal axis and a slot formed to include a longitudinally extending channel;
a second member disposed in the slot and including a longitudinally extending ridge for engaging the channel, the first and second members being disposed in the lock cylinder housing; and
a connector disposed to engage the first and second members to prevent longitudinal relative movement therebetween.

5. The turn piece extension of claim 4 wherein the first member includes a plurality of apertures and the second member includes a second aperture disposed for alignment with one of the plurality of apertures, the first member further including indicia associated with the plurality of apertures.

6. The turn piece extension of claim 4 wherein the first member includes a plurality of apertures and the second member includes a second aperture disposed for alignment with one of the plurality of apertures, the connector being configured to engage the one of the plurality of apertures and the second aperture.

7. A method of connecting a turn piece to a lock cylinder disposed in a lock cylinder housing comprising the steps of:
providing a multi-piece turn piece extension coupled to the turn piece;
determining the length of the turn piece extension necessary to connect the turn piece to the lock cylinder;
moving a first piece of the multi-piece extension relative to a second piece of the multi-piece extension to provide the determined length; and
locking the first and second pieces of the multi-piece extension together to prevent relative movement therebetween, and
inserting the multi-piece extension into the lock cylinder housing.

8. The method of claim 7 wherein the step of locking includes the steps of providing a first aperture in the first piece and a second aperture in the second piece, aligning the first and second apertures in registry, and inserting a pin through the first and second apertures.
